(19) United States
(12) Patent Application Publication
(10) Pub. No.: US 2013/0084976 A1
(43) Pub. Date: Apr. 4, 2013

(54) GAME PARADIGM FOR LANGUAGE LEARNING AND LINGUISTIC DATA GENERATION

(71) Applicants: Arumugam Kumaran, Bangalore (IN); Sumit Basu, Seattle, WA (US); Sujay Kumar Jauhar, Pondicherry (IN)

(72) Inventors: Arumugam Kumaran, Bangalore (IN); Sumit Basu, Seattle, WA (US); Sujay Kumar Jauhar, Pondicherry (IN)

(73) Assignee: MICROSOFT CORPORATION, Redmond, WA (US)

(21) Appl. No.: 13/251,225

(22) Filed: Oct. 1, 2011

(51) Int. Cl. A63F 9/24; G06F 17/20

(52) U.S. Cl. 463/30; 704/8; 704/E11.001

(57) ABSTRACT

The gaming and linguistic data generating technique described herein provides an online multiplayer game that can generate linguistic data, such as, for example, monolingual paraphrase data or multilingual parallel data, as a by-product of the game. The game is designed along the lines of sketch-and-convey paradigm. The game can be played as follows. A phrase is chosen from a phrase corpus and is given to one player (the “Drawer”) who then conveys it to the other player (the “Guesser”) by drawing a picture of the phrase. The Guesser guesses at the components of the phrase either in the same language as the phrase or possibly in a different language. If the Guesser's guesses converge to the chosen phrase, this generates monolingual paraphrases (if the game is played in the same language), and parallel text (if the game is played between multilingual players or two monolingual players in different languages).

### BACKGROUND

There are various drawing games on the market today. One popular board game allows one player to draw a picture while the other player verbally guesses what the picture represents. The focus in this game is to provide fun for the players, and no other tangible benefits arise from the players playing the game. For example, no auxiliary data generation or development of foreign language skills takes place

There have been various attempts to collaboratively generate auxiliary data for various purposes. Early attempts to generate data in a collaborative way have relied on the creation of knowledge in a structured way. In gaming paradigm, there is a “Games With A Purpose” (GWAP) series of games. Some of these games are extremely productive in generating auxiliary data. For example, in one language game, users provide ontological information about a given word. Another collaborative game allows players to tag photographs with metadata while playing the game, which can be used by search engines. None of these games, however, attempt to generate monolingual paraphrase data or multilingual parallel data, and none of these games allow users to learn a foreign language.

### SUMMARY

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

The gaming, linguistic data generating technique and the paradigm for language learning described herein provides an online multiplayer game that can generate linguistic data, such as, for example, monolingual paraphrase data or multilingual parallel data, as a by-product of the game. In different embodiments of the game, the players also have opportunities to learn linguistic concepts and elements from another language by means of a visual communication paradigm. The game is designed along the lines of sketch-and-convey paradigm.

In one embodiment of the technique, a concept (or text element, such as a phrase and used interchangeably herein) chosen from a phrase corpus expressed in one language (say, a word, phrase or sentence in language A) is given to one player (the “Drawer”), and the player conveys the concept to the other player (the “Guesser”) using sketching as the primary communication device. The concept or chosen text element or phrase is re-written by the Guesser in his/her own language B, yielding multilingual parallel data between languages A and B. Verification of the correctness may be performed manually by the “Drawer” or automatically by using Natural Language Processing (NLP) technologies (that can detect paraphrase data or parallel data). While having fun may be a primary incentive for a player to play the game, game points may also be accrued by both the Drawer and the Guesser as incentives. Also, one embodiment of the game is designed to provide higher rewards as players work with longer and more complex text elements. Thus the game can provide not only fun, but also a progressively challenging environment.

If the Guesser's guesses converge to the input phrase/text element or sentence, this provides a productive way for generating paraphrases (if the game is played between two monolingual players in the same language), and parallel text (if the game is played between multilingual players or two monolingual players in different languages).

Finally, in addition to the potential for generating monolingual paraphrase or multi-lingual parallel data, when played between players of different language backgrounds, embodiments of the technique can provide for language learning as well. Simple concepts—for example, chosen from a travel phrasebook—may be conveyed by pictures between two players, and users may also learn how it is written (or spoken) in a foreign language, during the game play.

### DESCRIPTION OF THE DRAWINGS

The specific features, aspects, and advantages of the disclosure will become better understood with regard to the following description, appended claims, and accompanying drawings where:

FIG. 1 depicts sample matching criteria for matching potential players in one exemplary embodiment of the gaming and linguistic data generating technique described herein.

FIG. 2 depicts a sample screen for the Drawer (in this case, an English speaker).

FIG. 3 depicts a sample screen for the Guesser (in this case, a Spanish speaker)

FIG. 4 is an exemplary architecture for practicing one exemplary embodiment of the gaming and linguistic data generating technique described herein.

FIG. 5 depicts a flow diagram of an exemplary process for practicing one embodiment of the gaming and linguistic data generating technique.

FIG. 6 depicts another flow diagram of another exemplary process for practicing one embodiment of the gaming and linguistic data generating technique.

FIG. 7 is a schematic of an exemplary computing environment which can be used to practice the gaming and linguistic data generating technique.

### DETAILED DESCRIPTION

In the following description of the gaming and linguistic data generating technique, reference is made to the accompanying drawings, which form a part thereof, and which show by way of illustration examples by which the gaming and linguistic data generating technique described herein may be practiced. It is to be understood that other embodiments may be utilized and structural changes may be made without departing from the scope of the claimed subject matter.

### 1.0 Gaming and Linguistic Data Generating Technique

The following sections provide an overview of the gaming and linguistic data generating technique, details of the technique, as well as an exemplary architecture and exemplary processes for practicing the technique.

1.1 Overview of the Technique

The gaming and linguistic data generating technique described herein provides an online multiplayer game that can generate monolingual paraphrase data or multilingual parallel data as a by-product of the game.

In general, in one embodiment of the technique the game is played as follows. A text element or phrase, herein used interchangeably, is chosen from a phrase corpus. This phrase is given to one player (the “Drawer”) who then conveys it to the other player (the “Guesser”) using sketching as the primary communication device. The Guesser guesses at the components of the phrase or concept either in the same language as the phrase or possibly in a different language. Verification of the correctness may be performed manually by the Drawer or automatically by using NLP technologies (that can detect paraphrase data or parallel data). If the Guesser's guesses converge to the chosen phrase, this generates monolingual paraphrases (if the game is played between two monolingual players in the same language), and parallel text (if the game is played between multilingual players or two monolingual players in different languages). This game is very useful for generating data that can be used for compiling thesaurus or dictionary data in monolingual space, or bi- or multi-lingual dictionaries and resources in multilingual space. At the sentence level, the technique can be used for generating parallel data for training machine translation systems or cross-language search systems.

The technique can also be used to simply allow two players that speak different languages to play together. This can provide for language learning as well. Simple concepts—for example, chosen from a travel phrasebook—may be conveyed by pictures between two players, and users may also learn how it is written (or spoken) in a foreign language, during the game play. One embodiment of the technique is designed as a learning environment in which learning a foreign language is emphasized through interaction with another native speaker of a foreign language, while playing a game.

An overview of the technique having been provided, the remaining paragraphs of this section provide some details of various aspects of playing various embodiments of the game according to the technique relating to the example discussed above.

1.2 Developing a Dataset of Travel-Oriented Phrases or Sentences

In most embodiments of the technique, it is desirable to obtain or create an appropriate corpus to be used for the Drawer to draw, and/or for which multi-lingual parallel language data or monolingual paraphrase data is sought. One embodiment of the technique uses a travel phrasebook corpus containing 1000 or so most-used sentences in travel contexts (specifically for a traveler in a foreign language situation) to choose a phrase for the Drawer to draw. However, it should be noted that many other relevant corpora can be mined from Web data, such as, for example, language related to particular modes of travel, certain activities (dining out, sightseeing, emergency assistance, and so forth) or the corpus can be based on occurrence statistics in a given language. This corpus or dataset can be further classified based on granularity (at which level the corpus level is referred to) and hardness for the Guesser to guess, so that the technique can serve out easier text elements to the players at first, and can gradually increase both hardness and granularity, to keep the game fun and challenging for the players. Hardness may be based on visual inspection, or circumstantially it may be based on using the time to complete the task by a number of users.

1.3 Setup: Matching Players

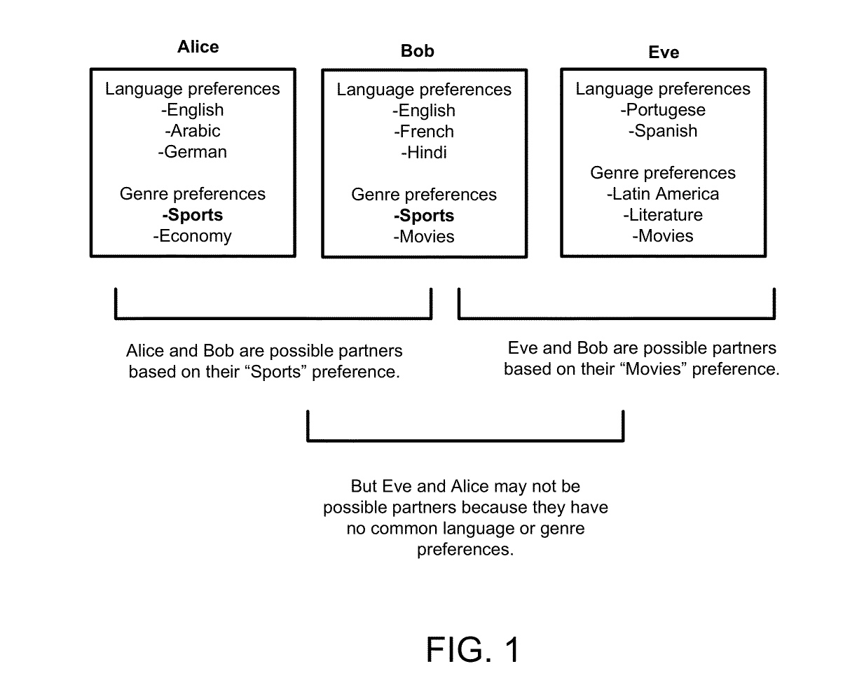

As discussed previously, players entering the system are matched to appropriate partners. This matching can be based, for example, on a combination of their preferences in terms of target languages they wish to learn, genre/domain preferences, and an assessment of their skills based on past performance in the game. An example of preference-based filtering 100 is shown in FIG. 1. As shown in FIG. 1, players Alice 102 and Bob 104 are probable matching candidates as they both prefer a “sports” category. Bob and Eve 106 are also probable matching candidates because they prefer a “movies” category. But Alice and Eve are probably not a good match because the have very little in common. The players' preferences can be obtained when they register to play the game.

1.4 Choosing an Appropriate Text Element

As discussed previously, in one embodiment of the technique, appropriate text elements must be chosen for use during gameplay. This set of text elements (words/phrases/sentence) may be chosen, for example, based on the player's preferences/areas of interest, their skill level as assessed from past game play, and on diversity requirements in sampling (e.g., it is undesirable to show ten restaurant-oriented sentences in a row, or to show previously played elements between the same two players, and so forth).

1.5 Core Game Flow

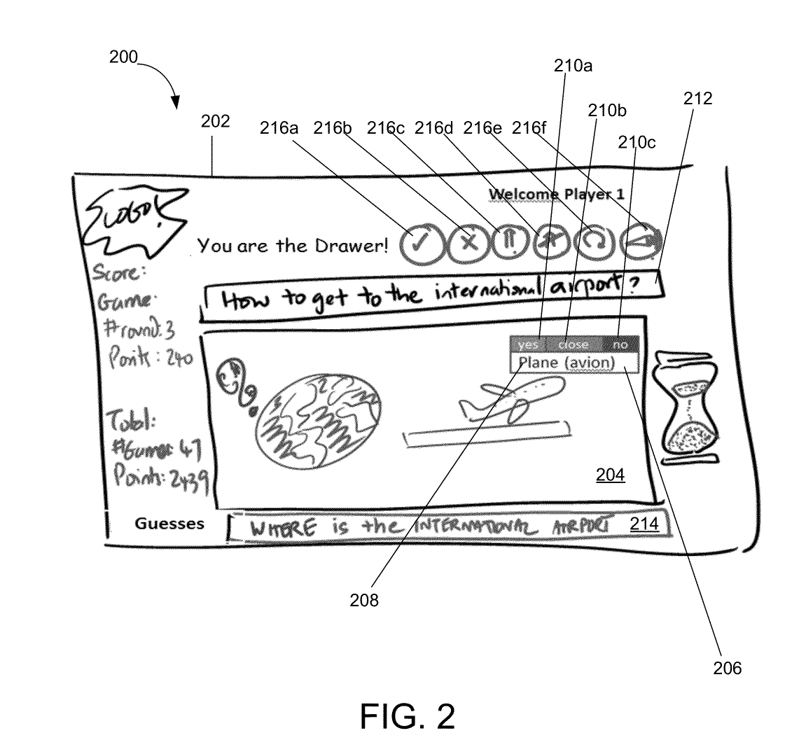

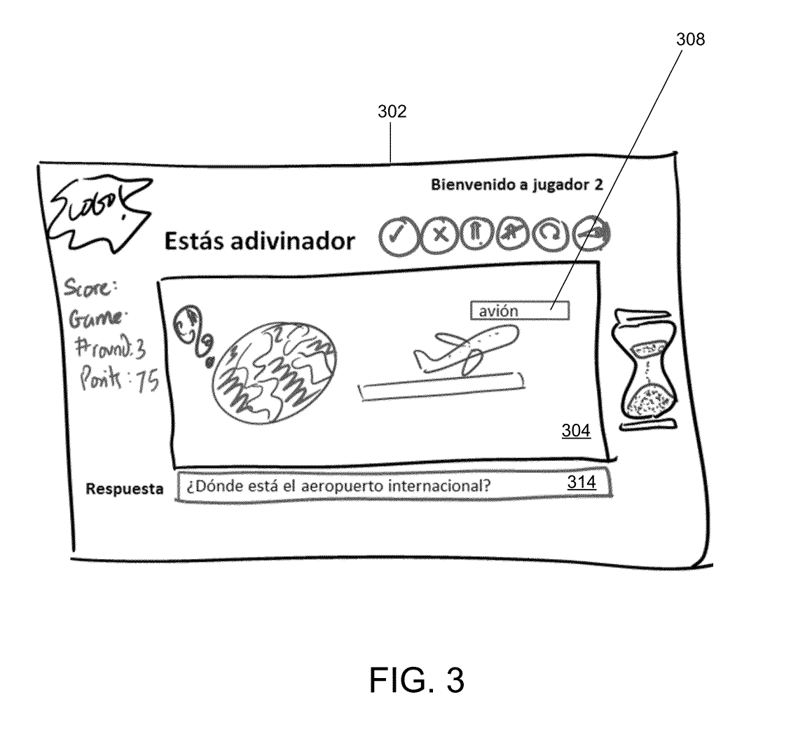

In one embodiment of the technique, there are two players; the Drawer and the Guesser that play the game. In brief, the Drawer is provided with a text element such as a phrase or a sentence (in her language if the game is multi-lingual) and will start drawing it in a canvas area of a computing device's display. The Guesser attempts to guess at parts of the drawing and will ultimately attempt to guess the overall text element. When the Guesser has guessed correctly or time runs out, the round is over, and points are assigned. FIGS. 2 and 3, respectively provide sample screen sketches 202, 302 for the Drawer to draw the picture of the chosen text element (displayed in box 212) and the Guesser to guess the picture's components and the entire phrase.

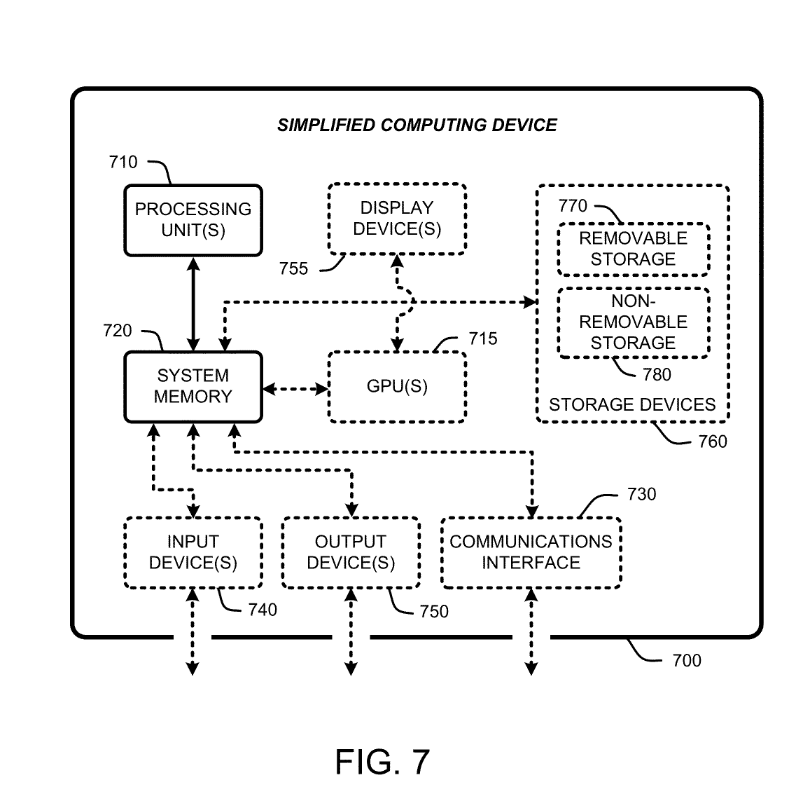

As shown in FIGS. 2 and 3, the area in the center with the images is the drawing canvas 204, 304. Each drawing canvas 204, 304 is displayed on a display of a computing device 700, which will be described in greater detail with respect to FIG. 7. As the Drawer draws images in their drawing canvas 204, they show up in the Guesser's window 304 as well. However, the Guesser cannot modify the drawing. The Guesser can click anywhere in the drawing and a text box 306 will appear, in which he can enter a guess for an individual item in the drawing. In this example, the Guesser clicked next to the airplane and wrote “avion”, the Spanish word for airplane. The Drawer sees not only the original Spanish word (“avion”) 206 typed by the Guesser, but also its English translation (“plane”, in this case) 208. The Drawer now can click one of the meta-information buttons 210a, 210b, 210c displayed along with the text box, to signify the relative correctness of the guess. This also gives the Drawer an opportunity to see the paired word, which can improve her vocabulary in the foreign language. If she now clicks “yes” on the word, the Guesser will see both language version as well (“avion (plane)”), so he will have a chance to learn the word pair as well.

In one embodiment of the technique, there are additional elements to assist with the game play that are in the user interface and that provide icons for common gestures which are particularly useful when two players speak different languages. Among these are five icons to allow the Drawer to rapidly communicate common response to the Guesser. In one exemplary embodiment these icons include “Done” 216a, “Wrong” 216b, “Yes, you are going in the right direction” 216c, “No, you are not going in the right direction” 216d, “Try similar concept” 216e, and “Sounds like . . . ” 216f. Of course many other icons could be employed to provide guidance to the guesser such as “Split word” or “Try opposite concept”, for example.

Every time the “Yes” button 212 is clicked on a text box by the Drawer, the text element drops to the Progressive Guesses Box (PGB) 214, 314 at the bottom (called “Guesses” in the Drawer's screen, and “Respuesta” in Guesser's screen in this example), where all the correct words accumulate. Once the Guesser thinks he knows the entire phrase, he can type it (or rearrange the words already there). At that point, the technique can automatically make a (noisy) assessment of the correctness of the translation, and assign appropriate scores for each player depending on the correctness and time taken (refer to the ‘Verification’ Section below for details). The Drawer can optionally help with this assessment by looking at a noisy translation (based on word lookup, or whatever the best translation mechanism available is) and then making a judgment on whether the guess is correct. In one embodiment, the players' scores are then updated based on how much time they took to complete the round, and how accurate their convergence is.

1.6 Verification

To ensure that the Guesser's guesses are correct they must be verified. Scoring of the guesses by the Guesser may be done automatically, based on linguistic resources (such as, mono- or bi-lingual dictionaries, thesauri, etc., along with the frequency information from large corpora) or by using Natural Language Processing tools and technologies (such as, probabilistic dictionaries, cross-language name and phrase identification components, and so forth). It is important to note that even among human judges, the verification can result only in a range of answers, and never a binary answer.

One embodiment of the technique employs a cut off for scoring whether the Guesser's guess is acceptable. Such a criteria, while introducing noise (perhaps perfect translations, but also near equivalents with erroneous parts of the phrase/sentences, will pass this criteria), has two advantages: (1) It makes the games easier for the players since there is some slack, thereby, leading to more closures of game rounds; and (2) It makes the data gathered a bit more diverse (though noisy), which is well suited for the purpose of generating data for training cross-language tools and technologies. In addition, such a configurable acceptance criteria has an advantage of controlling the game dynamics (to make it easier or harder) depending on the end-data-need, and user-dynamics.

Finally, in one embodiment of the technique, the verification mechanism can also be spawned out to a crowd of others playing the game in real time, i.e. getting other gamers to act as verifiers in return for a small game reward.

1.7 Leaderboard and Community

In order to add a competitive and social aspect to the game, in one embodiment of the gaming and linguistic data generating technique, there is a “leaderboard” of top scorers, as well as the ability to post scores to social networking sites. In order to keep people interested in playing the game, some embodiments of the technique that display separate rankings at different skill levels, for different language pairs, and so forth.

1.8 Cheating

As with any game, there is the opportunity for cheating. For instance, in the example above, if the Drawer already knew Spanish, she could simply write out the sentence in Spanish after seeing it in English and the Guesser could enter that. Likewise, if the Guesser knew English (and the Drawer was aware of this), the Drawer could just write out the English phrase, and the Guesser could write down the translation in Spanish. Note, though, that in either case, this type of cheating only helps, as some of the goals of the game are to (1) collect parallel and paraphrase language data and (2) to encourage language learning. For the first goal, cheaters provide good data even more quickly by just typing in parallel language data. For the second goal, the better the players get at “cheating,” the more they learn the foreign language, and the better they will be at the game. Thus learning the foreign language is a means of improving their performance in the game, and as such will encourage them to improve their skills.

An overview and general aspects of the technique having been discussed the following sections will provide a description of an exemplary architecture and exemplary processes for practicing various embodiments of the technique.

1.9 Exemplary Architecture

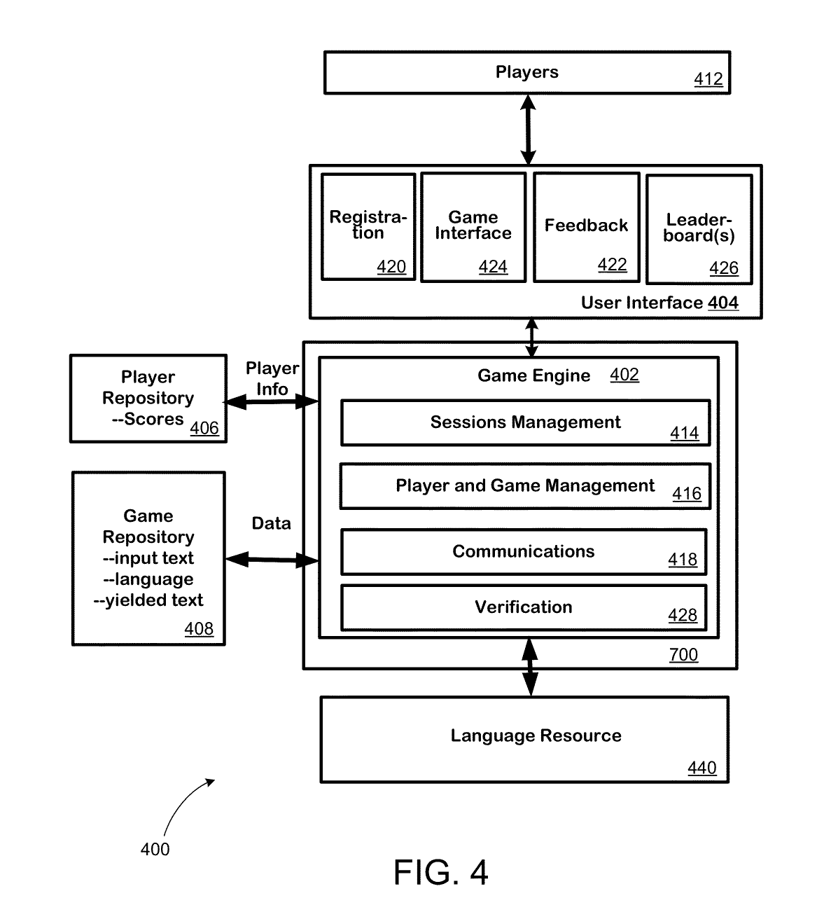

FIG. 4 shows an exemplary architecture 400 for practicing one embodiment of the gaming and linguistic data generating technique. As shown in FIG. 4, this exemplary architecture includes a game engine 402. The game engine 402 interfaces with a user interface 404 that displays the game on a display device and allows users/players 412 to interface with the game. In one exemplary embodiment of the architecture 400, the game engine 402 resides on a general purpose computing device 700, which will be described later in greater detail with respect to FIG. 7. In one exemplary embodiment of the technique, the game engine 402 resides on one or more computing devices, for example, one or more servers and/or in a computing cloud and players connect to the server(s)/computing cloud via a network, such as the Internet, from their own computing device.

The game engine 402 also interfaces with a player repository 406 and a game repository 408. In one embodiment of the technique, the game engine 402 also interfaces with a language resource module 410 which is used by a verification module 428 of the game engine 402 to determine the validity of a Guesser's guesses compared to the phrase selected from the corpora.

The game engine 402 includes a sessions management module 414, a player and game management module 416, a verification module 428 and a communications module 418. These are described in greater detail below.

1.9.1 Player and Game Management

The player and game management module 416 of the game engine 402 is the framework that manages the game flow—for example, it performs game management, corpora management and game session management. In game management, for example, the player and game management module 416 keeps track of player IDs, player scores, matches players and also manages one or more leaderboards. In corpora management player and game management module 416 harvests text for the chosen phrases, selects the chosen phrase and manages player-to-corpora relationships (e.g., has a player been involved in drawing or guessing a chosen phrase previously).

1.9.2 Session Management

A game consists of a consecutive set of sessions between the same two players. In session management, a session management module 414. The game engine 402 manages appropriate pairing of the drawing and guessing players. The session management module 414 also manages multiple “rounds” and serves text pieces from the corpora (e.g., the chosen phrases) and verifies the players guesses for these text pieces. During session management answers are scored appropriately and scores/leaderboards are updated. Between rounds the guessing player and the drawing player can switch. The game engine can also choose increasingly challenging text pieces for higher score rewards.

1.9.3 Communications

The communications module 418 manages the communications between the players 412 via the game interface 424. This includes, for example, drawings made by the drawer, guesses entered by the guesser both next to a drawing element and in the guess box, and button presses by the drawer giving feedback to the guesser.

1.9.4 The Player Repository

The player repository 406 manages and stores player information and also manages and stores all text items “solved” between a given pair of players. Player data is gathered at a one-time registration session during which user demographic data is gathered. Such demographic data can include, for example, location, languages known, domains of interest, and level of proficiency (novice to expert). Players get paired/matched randomly with another similar profile, dynamically.

1.9.5 Corpora Repository

The corpora repository 410 manages and stores corpora information, such as, for example, corpora pieces (e.g., words, phrases, sentences), level of difficulty and the language of the game. There are also linguistic resources associated with this piece of text, such as, for example, dictionary information (mono- and bi-lingual definitions) thesaurus information, translations (with a confidence scores) and previous solutions for text elements/phrases from other users and sessions. The corpora could be, for example, a simple phrase book for tourists.

1.9.6 Verification and Language Resources

The verification module 428 of the game engine 402 employs various language resources in a language resource module 410 for verification of a players guesses of the chosen phrase's components. For example, in some embodiments the technique uses dictionaries and thesauri for verification of word level data. For cross-lingual games bilingual dictionaries can be used to verify word-level data. Word nets and interlinking (psycholinguistic resources that map mental concepts to words in a language) can also be used. Machine translation systems and/or cross-language information retrieval (CLIR) systems can also be used for automatic verification with some confidence levels. Additionally, previous user session data can be used for verification, or the Drawer or other players can manually verify the Guesser's guesses.

1.9.7 User Interface

As discussed previously, the game engine 402 interfaces with the user interface 404 for a user or player 412 to interface with the game (e.g., input a drawing or text and make associated guesses). The user interface 404 has modules for handling user registration 420, user feedback 422, and display and interaction with game components 424 (e.g., drawing, guesses, display of a phrase obtained from the phrase corpus). The UI also displays any leaderboards 426.

More specifically, in one embodiment the technique employs a simple user interface 404 for managing game flow. This user interface 404 can include a clock, a simple canvas (with pens, brushes and colors) that is editable for the drawing player but not the guessing player, a global text input box for the guessing player to enter his or her guess for the entire phrase, the ability for the guesser to place a text box anywhere in the drawing for the player to guess a particular object (the drawing player will see these boxes with the text in both languages, if applicable, and can indicate whether the word for the object is right, wrong or close, etc.). The user interface can also include a feedback window to the guessing player. The user interface can also include a frame with a leaderboard.

1.2 Exemplary Processes for Practicing the Technique

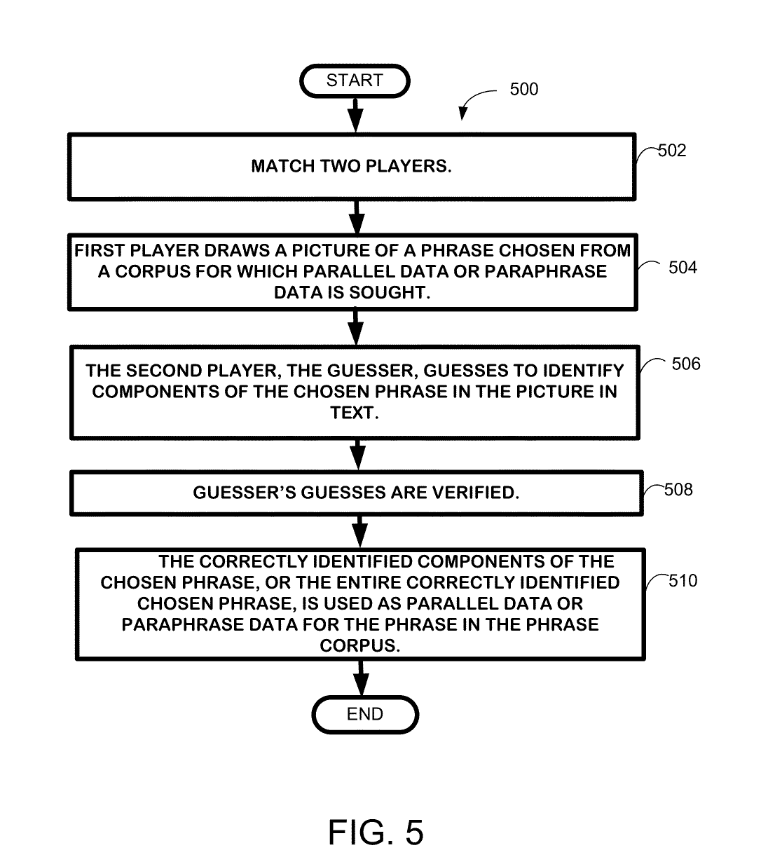

FIG. 5 shows an exemplary process 500 for collecting parallel language data (or paraphrase data) by using the technique. As shown in FIG. 5, block 502, two players are matched. For example, the players can be matched by the genre of phrases they would like to guess, or what type of language they would like to play the game in. As shown in block 504, the first player of the two players draws a picture of a chosen phrase from a phrase corpus for which multi-lingual parallel language data (or monolingual paraphrase data) is sought. This phrase may be chosen based on the difficulty of guessing the phrase, and/or the phrase may be chosen based on the previous history the two players have playing the game. For example, if a phrase had been previously been presented to these two players it probably would not be chosen for presentation to them again. Once the first player, the Drawer, draws a picture representing the chosen phrase, the second player, the Guesser, makes guesses to identify components of the chosen phrase in the picture in text, as shown in block 506. The second player can identify the components in the same language as the phrase corpus, or can identify components of the chosen phrase in a language other than the language of the phrase corpus. The Guesser's guesses are verified, as shown in block 508. For example, automatic scoring of player-identified components of the chosen phrase in the picture can take place. The correctly identified components of the chosen phrase are then used to provide multi-lingual parallel language data or monolingual paraphrase data for the chosen phrase in the phrase corpus, as shown in block 510.

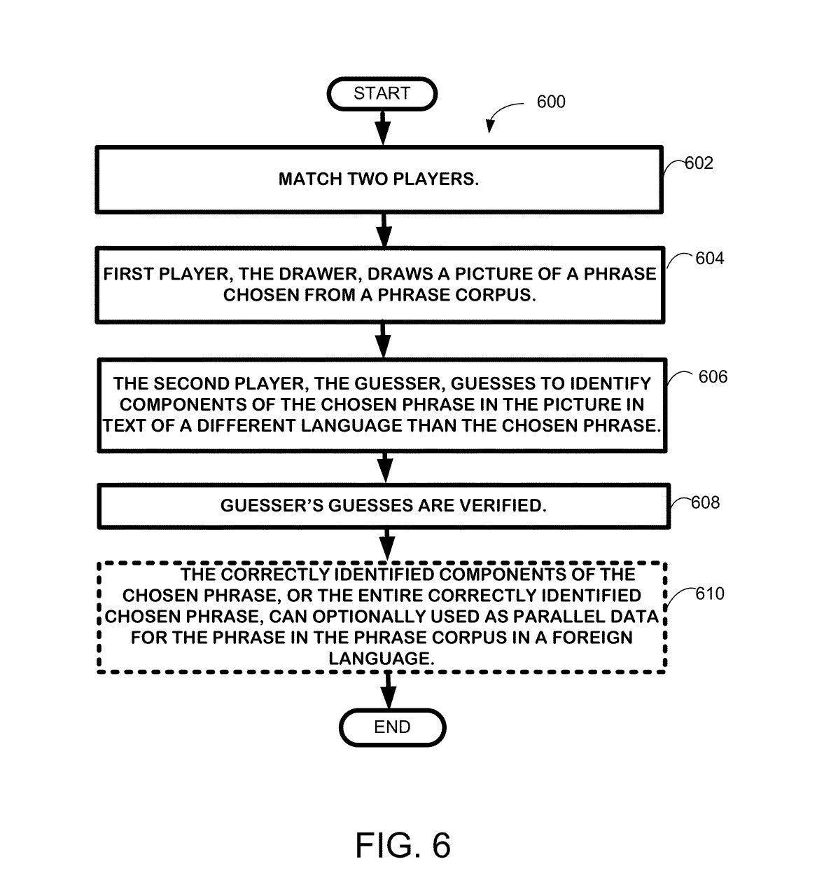

FIG. 6 shows another exemplary process 600 for practicing one embodiment of the gaming and linguistic data generating technique that allows for players to play a cross-language picture drawing game. As shown in block 602, two players are matched. The players can be matched, for example, based on language preferences and genre preferences. The first player, the Drawer, draws a picture of a chosen phrase from a phrase corpus, as shown in block 604. The second player identifies components of the chosen phrase in the picture in text of a different language than the chosen phrase, as shown in block 606. The second player's guesses that are provided in the different language are verified based on how close the second player comes to correctly identifying one or more components of the chosen phrase, as shown in block 608. For example, the second player's guesses can be verified based on a dictionary look-up. Or the second player's guesses can be verified based on automatic evaluation, for example based on linguistic resources, like dictionaries, or can be verified based on technologies, like machine translation or multilingual paraphrase identification or other technologies. The correctly identified components of the phrase can optionally be used to provide multi-lingual parallel language data for the chosen phrase in the phrase corpus, as shown in block 610. The generated parallel data can then be used, for example, for training a machine translation system or a cross-language search system.

### 2.0 Exemplary Operating Environments

The gaming and linguistic data generating technique described herein is operational within numerous types of general purpose or special purpose computing system environments or configurations. FIG. 7 illustrates a simplified example of a general-purpose computer system on which various embodiments and elements of the gaming and linguistic data generating technique, as described herein, may be implemented. It should be noted that any boxes that are represented by broken or dashed lines in FIG. 7 represent alternate embodiments of the simplified computing device, and that any or all of these alternate embodiments, as described below, may be used in combination with other alternate embodiments that are described throughout this document.

For example, FIG. 7 shows a general system diagram showing a simplified computing device 700. Such computing devices can be typically be found in devices having at least some minimum computational capability, including, but not limited to, personal computers, server computers, hand-held computing devices, laptop or mobile computers, communications devices such as cell phones and PDA's, multiprocessor systems, microprocessor-based systems, set top boxes, programmable consumer electronics, network PCs, minicomputers, mainframe computers, audio or video media players, etc.

To allow a device to implement the gaming and linguistic data generating technique, the device should have a sufficient computational capability and system memory to enable basic computational operations. In particular, as illustrated by FIG. 7, the computational capability is generally illustrated by one or more processing unit(s) 710, and may also include one or more GPUs 715, either or both in communication with system memory 720. Note that that the processing unit(s) 710 of the general computing device of may be specialized microprocessors, such as a DSP, a VLIW, or other micro-controller, or can be conventional CPUs having one or more processing cores, including specialized GPU-based cores in a multi-core CPU.

In addition, the simplified computing device of FIG. 7 may also include other components, such as, for example, a communications interface 730. The simplified computing device of FIG. 7 may also include one or more conventional computer input devices 740 (e.g., pointing devices, keyboards, audio input devices, video input devices, haptic input devices, devices for receiving wired or wireless data transmissions, etc.). The simplified computing device of FIG. 7 may also include other optional components, such as, for example, one or more conventional computer output devices 750 (e.g., display device(s) 755, audio output devices, video output devices, devices for transmitting wired or wireless data transmissions, etc.). Note that typical communications interfaces 730, input devices 740, output devices 750, and storage devices 760 for general-purpose computers are well known to those skilled in the art, and will not be described in detail herein.

The simplified computing device of FIG. 7 may also include a variety of computer readable media. Computer readable media can be any available media that can be accessed by computer 700 via storage devices 760 and includes both volatile and nonvolatile media that is either removable 770 and/or non-removable 780, for storage of information such as computer-readable or computer-executable instructions, data structures, program modules, or other data. By way of example, and not limitation, computer readable media may comprise computer storage media and communication media. Computer storage media includes, but is not limited to, computer or machine readable media or storage devices such as DVD's, CD's, floppy disks, tape drives, hard drives, optical drives, solid state memory devices, RAM, ROM, EEPROM, flash memory or other memory technology, magnetic cassettes, magnetic tapes, magnetic disk storage, or other magnetic storage devices, or any other device which can be used to store the desired information and which can be accessed by one or more computing devices.

Storage of information such as computer-readable or computer-executable instructions, data structures, program modules, etc., can also be accomplished by using any of a variety of the aforementioned communication media to encode one or more modulated data signals or carrier waves, or other transport mechanisms or communications protocols, and includes any wired or wireless information delivery mechanism. Note that the terms “modulated data signal” or “carrier wave” generally refer a signal that has one or more of its characteristics set or changed in such a manner as to encode information in the signal. For example, communication media includes wired media such as a wired network or direct-wired connection carrying one or more modulated data signals, and wireless media such as acoustic, RF, infrared, laser, and other wireless media for transmitting and/or receiving one or more modulated data signals or carrier waves. Combinations of the any of the above should also be included within the scope of communication media.

Further, software, programs, and/or computer program products embodying the some or all of the various embodiments of the gaming and linguistic data generating technique described herein, or portions thereof, may be stored, received, transmitted, or read from any desired combination of computer or machine readable media or storage devices and communication media in the form of computer executable instructions or other data structures.

Finally, the gaming and linguistic data generating technique described herein may be further described in the general context of computer-executable instructions, such as program modules, being executed by a computing device. Generally, program modules include routines, programs, objects, components, data structures, etc., that perform particular tasks or implement particular abstract data types. The embodiments described herein may also be practiced in distributed computing environments where tasks are performed by one or more remote processing devices, or within a cloud of one or more devices, that are linked through one or more communications networks. In a distributed computing environment, program modules may be located in both local and remote computer storage media including media storage devices. Still further, the aforementioned instructions may be implemented, in part or in whole, as hardware logic circuits, which may or may not include a processor.

It should also be noted that any or all of the aforementioned alternate embodiments described herein may be used in any combination desired to form additional hybrid embodiments. Although the subject matter has been described in language specific to structural features and/or methodological acts, it is to be understood that the subject matter defined in the appended claims is not necessarily limited to the specific features or acts described above. The specific features and acts described above are disclosed as example forms of implementing the claims.

What is claimed is:

1. A computer-implemented process for collecting multi-lingual parallel language data or monolingual paraphrase data by using a drawing game, comprising:
matching two players;
a first player of the two players drawing a picture of a chosen phrase from a phrase corpus for which multi-lingual parallel language data or monolingual paraphrase data is sought;
a second player of the two players guessing to identify components of the chosen phrase in the picture in text;
verifying the guesses of the identified components of the chosen phrase; and
using the identified phrase or components of the chosen phrase to provide multi-lingual parallel language data or monolingual paraphrase data for the chosen phrase in the phrase corpus.

2. The computer-implemented process of claim 1, further comprising automatically scoring player-identified components of the chosen phrase in the picture.

3. The computer-implemented process of claim 2, wherein the second player identifies components of the chosen phrase in a language other than the language of the phrase corpus.

4. The computer-implemented process of claim 3, wherein the two players are matched in terms of preferred languages, preferred genres, and the player's self-declared or system-evaluated skill level.

5. The computer-implemented process of claim 1, wherein the chosen phrase is chosen based on degree of difficulty for a player to guess components of the phrase.

6. The computer-implemented process of claim 1, further comprising displaying a user interface to allow the first player to draw the picture representing the chosen phrase on a first display, and wherein the second player guesses components of the picture of the chosen phrase by typing words representing the components in text on a second display that also displays the picture.

7. The computer-implemented process of claim 6, wherein elements are displayed on the first and second displays that assist the second player by providing an indication of whether the second player's guesses are close or not close to the chosen phrase.

8. The computer-implemented process of claim 1, wherein either the first or second player cheats by writing out in text the chosen phrase without guessing the components of the picture, and wherein the written out phrase is used as the multi-lingual parallel language data or mono-lingual parallel data for the chosen phrase.

9. A computer-implemented process for playing a cross-language picture drawing game, comprising:
matching two players;
a first player drawing a picture of a chosen phrase from a phrase corpus;
a second player identifying components of the chosen phrase in the picture in text of a different language than the chosen phrase; and
verifying the second player's guesses provided in the different language based on how close the second player comes to correctly identifying one or more components of the chosen phrase.

10. The computer-implemented process of claim 9, further comprising using correctly identified components of the phrase to provide parallel language data for the chosen phrase in the phrase corpus in a foreign language.

11. The computer-implemented process of claim 9, wherein the second player's guesses are verified by one or more other players.

12. The computer-implemented process of claim 9, wherein the second player's guesses are verified based on a dictionary look-up.

13. The computer-implemented process of claim 9, wherein the second player's guesses are verified based on a machine-translation of the chosen phrase.

14. The computer-implemented process of claim 9, wherein the generated parallel data is used for training a machine translation system or a cross-language search system.

15. A system for playing a cross-language game to help players learn a foreign language while generating parallel language data for a phrase corpus, comprising:
a general purpose computing device;
a computer program comprising program modules executable by the general purpose computing device, wherein the computing device is directed by the program modules of the computer program to,
obtain a phrase corpus for which parallel language data is sought;
match two players;
allow a first player of the two players to draw a picture of a chosen phrase from the phrase corpus;
allow a second player of the two players to identify components of the chosen phrase in the picture in text;
display the text of the chosen phrase or components of the chosen phrase next to the text of the second players identified phrase or components of the chosen phrase;
verify the second player's identified components of the chosen phrase; and
use correctly identified components of the phrase to provide parallel language data for the chosen phrase in the phrase corpus.

16. The system of claim 15, wherein the parallel language data is in a different language from the phrase corpus.

17. The system of claim 15, wherein the first player draws the picture on a first display and wherein the second player identifies the components of the chosen phrase in the picture in text on a second display that is remote to the first display.

18. The system of claim 16, wherein the sub-module to verify the identification of the components of the picture verifies the components via automatic methods.

19. The system of claim 15 wherein displaying the second player's identified components next to corresponding components of the chosen phrase provides language learning for both players.

20. The system of claim 15 wherein the module to verify the second player's guesses further comprises verification by one or more other players.
